(19) United States
(12) Patent Application Publication
(10) Pub. No.: US 2026/0091959 A1
(43) Pub. Date: Apr. 2, 2026

(54) Ben- Lift (The Ben)

(71) Applicant: Tonnie Buggs, Katy, TX (US)

(72) Inventor: Tonnie Buggs, Katy, TX (US)

(21) Appl. No.: 18/901,609

(22) Filed: Sep. 30, 2024

(51) Int. Cl. B66C 19/00

(52) U.S. Cl. CPC B66C 19/005

(57) ABSTRACT

The present invention, called Ben-Lift (The Ben), is an equipment and generator lift device designed to enable a single individual to lift and transport heavy objects with ease and efficiency. The device features two removable bases for stability, four wheels for mobility, and a mechanism to attach and operate a hoist for lifting operations. The Ben-Lift (The Ben) is further equipped with a handle or similar means to facilitate pushing and pulling during transport. Its compact, modular design allows for easy assembly, disassembly, and storage, making it versatile for use in various industrial, commercial, and personal settings. The device reduces the physical effort required for lifting and moving heavy loads, enhancing safety and productivity.

### BACKGROUND OF THE INVENTION

### Field of Invention

The present invention relates to lifting and transportation equipment, specifically an apparatus designed to assist individuals in lifting and moving heavy machinery, such as generators, to designated installation locations. This invention provides a portable and adjustable lifting mechanism that reduces the physical strain and manpower traditionally required for such tasks.

### Background of Related Art

The installation and relocation of heavy equipment, particularly generators, often require multiple individuals or specialized machinery, such as forklifts or cranes. These methods can be costly, require significant coordination, and are not always feasible in confined spaces or residential settings. Traditional lifting devices may lack mobility, require permanent installation, or necessitate external power sources, limiting their versatility and efficiency.

The disclosed invention, known as the Ben-Lift, addresses these challenges by providing a compact, mobile, and adjustable lifting system. Equipped with a U-shaped frame, removable base, and manual or electronic hoist, this device enables a single operator to lift and transport heavy equipment with minimal effort. The inclusion of both stationery and swivel wheels enhances maneuverability, while attachment points allow for the integration of additional utility devices to further assist in movement. By eliminating the need for multiple workers or expensive lifting equipment, the Ben-Lift offers a practical, cost-effective, and user-friendly solution for moving and positioning generators and other heavy machinery.

### SUMMARY OF THE INVENTION

In one embodiment, the disclosure includes an equipment lifting and moving device comprising a frame defining a squared U-shaped lower portion formed by a bottom frame attachment, a pair of opposing vertical attachments, and a horizontal attachment connecting the vertical attachments; a removable base detachably configured to engage the frame and including at least one base plate having pin slots; a plurality of fastening pins adapted to engage the pin slots of the removable base for securing the base to the frame; a hoist attachment platform positioned on the frame for receiving a manual or electronic hoist; and a set of wheels operatively connected to the frame. Additionally, the equipment lifting device further comprises a hoist positioned on the hoist attachment platform. Additionally, the equipment lifting device includes a set of wheels that comprise at least one swivel wheel. These and other features will be more clearly understood from the following detailed description taken in conjunction with the accompanying drawings and claims.

### BRIEF DESCRIPTION OF THE DRAWINGS

FIG. 1 is a side view of the Ben-Lift (equipment lift with removable base) with details of the removable base bars and pin sets according to an embodiment of the disclosure;

FIG. 2 is a side view of the Ben-Lift showing the location of the pins and the removable base according to an embodiment of the disclosure;

FIG. 3 is a view of Ben-Lift's removable base and pins according to an embodiment of the disclosure;

FIG. 4 is a front view of Ben-Lift with illustrations showing the four wheels and removable bases and pin slots according to an embodiment of the disclosure.

### DETAILED DESCRIPTION OF THE INVENTION

The following detailed description is of the best currently contemplated modes of carrying out exemplary embodiments of the invention. The description is not to be taken in a limiting sense but is made merely for the purpose of illustrating the general principles of the invention, since the scope of the invention is best defined by the appended claims.

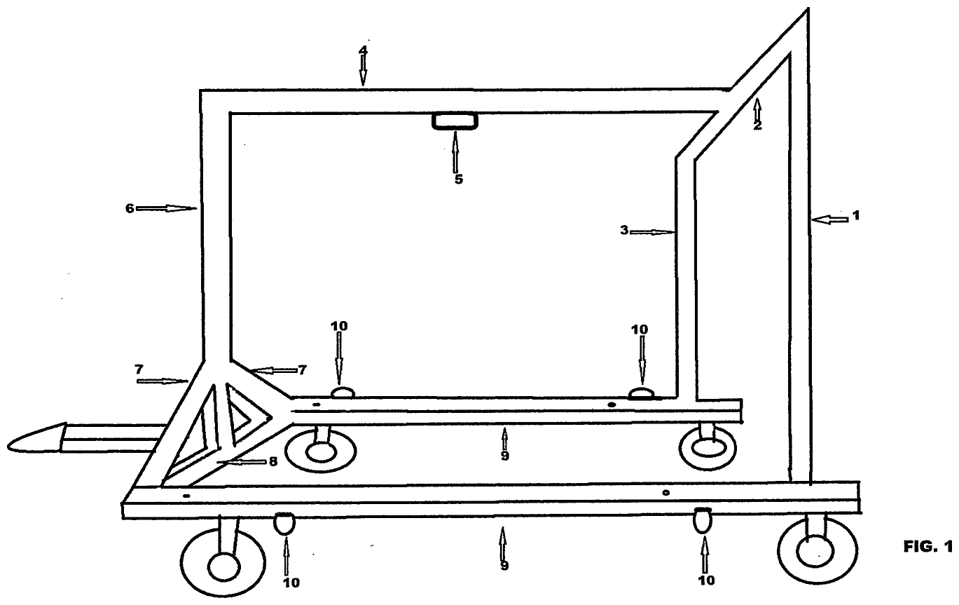

With reference now to the drawings, and in particular to FIGS. 1 through 4 references a new equipment lifting and moving device designed to lift and move generators and other equipment to installation locations. The device as noted in FIG. 1 is comprised of lower bottom frame Attachment 9 attached to frame 6 creating a squared U shape. The bottom U shaped from has attachments 1 and 3 vertical on each attachment 9. As noted in FIG. 1, attachment 2 connects to attachments 1 and 3 horizontally. As referenced in FIG. 1, Attachment 6 is attached to the center of attachment 8 with attachment 7 providing additional support to attachment 6. Attachment 4 is attached to the center of attachment 2 and the top of attachment 6. Attachment 5 is in the center of attachment 4 and is used to hold a manual or electronic hoist.

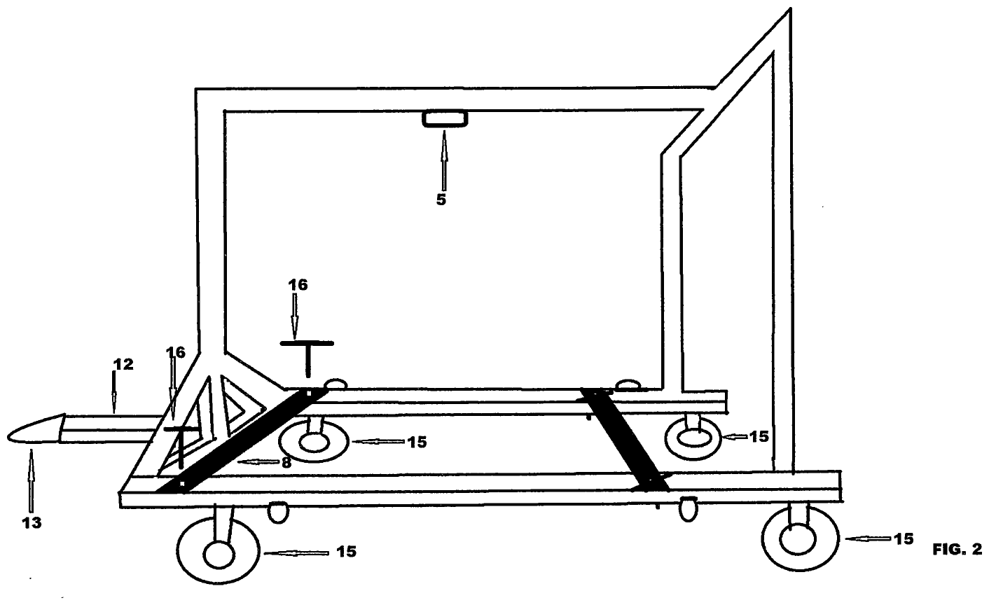

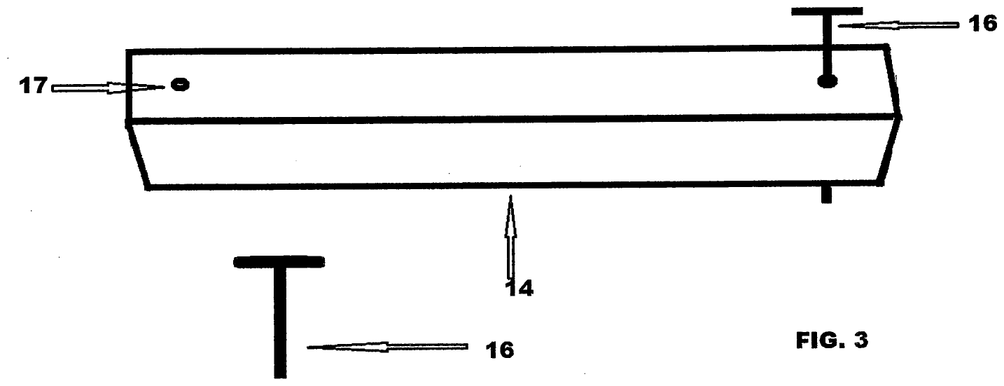

As referenced in FIG. 2 The underling frame of the equipment lift has attachment 15 (four wheels) both stationary and swivel wheels are used. As noted in FIG. 2, attachments 12 and 13 are connected to Attachment 8 and are used to attach mobile or manual utility devices to assist in moving the equipment lift. In FIG. 3, attachment 14 is one of two removable bases used to hold equipment when lifted. Also in FIG. 3, attachment 14 shows pin holes Attachment 17 for Pins shown as attachment 16. As shown in FIG. 1, attachments 14, 16 and 17 are connected to both attachments 9.

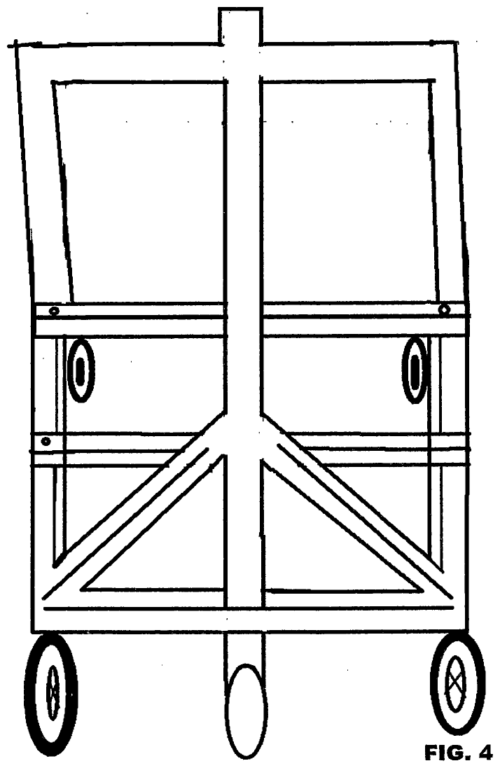

FIG. 4 shows the front of the equipment lift with the removable base attached.

With respect to the above description then, it is to be realized that the optimal dimensional relationship for the parts of an embodiment enabled by the disclosure to include variations in size, material, shape, form, function and manner of operation, assembly and use, are deemed readily apparent and obvious to one skilled in the art, and all equivalent relationships to those illustrated in the drawings and described in the specifications are intended to be encompassed by an embodiment of the disclosure.

Therefore, the foregoing is considered illustrative only of the principles of the disclosure. Further, since numerous modifications and changes will readily occur to those skilled in the art, it is not desired to limit the disclosure to the exact construction and operation shown and described and accordingly, all suitable modifications and equivalents may be resorted to, falling within the scope of the disclosure. In this patent document, the word “comprising” is used in its non-limiting sense to mean that the items following the words are included, but items not specifically mentioned are not excluded. A reference to an element by the indefinite article “a” does not exclude the possibility that more than one element is present, unless the context clearly requires that there be only one of the elements.

It should be understood, of course, that the foregoing relates to exemplary embodiments of the invention and that modifications may be made without departing from the spirit and scope of the invention as set forth in the following claims.

1. (canceled)

2. (canceled)

3. (canceled)

4. (canceled)

5. (canceled)

6. An equipment lifting and moving device, comprising:
a frame defining a squared U-shaped lower portion formed by a bottom frame attachment, a pair of opposing vertical attachments, and a horizontal attachment connecting the vertical attachments;
at least one removable base detachably configured to engage the frame and including at least one base plate having pin slots;
a plurality of fastening pins adapted to engage the pin slots of the at least one removable base for securing the base to the frame;
a hoist attachment platform positioned on the frame for receiving a manual or electronic hoist;
a set of wheels operatively connected to the frame.

7. The equipment lifting device of claim 6, further comprising:
a hoist positioned on the hoist attachment platform.

8. The equipment lifting device of claim 6, wherein the set of wheels include at least one swivel wheel.
